(19) United States
(12) Patent Application Publication
(10) Pub. No.: US 2014/0145922 A1
(43) Pub. Date: May 29, 2014

(54) LCD PANEL DRIVING METHOD AND DRIVING CIRCUIT

(71) Applicant: SHENZHEN CHINA STAR OPTOELECTRONICS TECHNOLOGY CO., LTD, Shenzhen (CN)

(72) Inventor: Yinhung Chen, Shenzhen (CN)

(73) Assignee: SHENZHEN CHINA STAR OPTOELECTRONICS TECHNOLOGY CO., LTD, Shenzhen (CN)

(21) Appl. No.: 13/807,272

(22) PCT Filed: Dec. 7, 2012
(86) PCT No.: PCT/CN2012/086091

§ 371 Date: Dec. 27, 2012

(30) Foreign Application Priority Data
Nov. 23, 2012 (CN) 201210482677.4

(51) Int. Cl. G09G 3/36

(52) U.S. Cl. CPC G09G 3/3648
USPC 345/94

(57) ABSTRACT

The present disclosure provides a liquid crystal display (LCD) panel driving method and a driving circuit. The method includes sending the scanning waveform to the LCD panel after the scanning waveform includes a chamfered section by control of a chamfer circuit to drive the LCD panel. The scanning waveform includes at least two chamfered sections having different slopes in each scanning period of the scanning waveform.

### TECHNICAL FIELD

The present disclosure relates to the manufacture field of a liquid crystal display (LCD), and more particularly to an LCD panel driving method and a driving circuit.

### BACKGROUND

In order to improve uniformity of a liquid crystal display (LCD) panel, a feedback voltage and a line change effect should be reduced. In U.S. Pat. No. 7,027,024, a chamfer circuit is used in an LCD driving system, where a driving voltage waveform is adjusted by the chamfer circuit to enable the driving voltage waveform to include chamfered sections having a certain slope (a slope here refers to an included angle between the voltage waveform and a horizontal line, where the voltage waveform is considered to be horizontal or vertical when the included angle is 0° or 90°, namely the voltage waveform has no slope), and then the voltage waveform is output to scan lines of the LCD panel. Generally, all components of the chamfer circuit are arranged on a control board of a LCD driving system.

As shown in FIG. 12, a scanning waveform of a scan voltage signal (VG) comprises a chamfered section. However, for different LCD panels, in particular some LCD panels with a large size, the line change effect is more obvious, and the uniformity (uniformity of display effect of upper, lower, left and right areas of the LCD panel) effect is still not good enough.

### SUMMARY

In view of the above-described problems, the aim of the present disclosure is to provide a liquid crystal display (LCD) panel driving method, and a driving circuit thereof capable of improving the uniformity and adjustment accuracy of the LCD panel.

The aim of the present disclosure is achieved by the following technical scheme.

An LCD panel driving method comprises: sending a scanning waveform to the LCD panel when the scanning waveform comprises a chamfered section by control of a chamfer circuit to drive the LCD panel. The scanning waveform comprises at least two chamfered sections having with different slopes in the each scanning period.

In one example, at least two chamfered sections having with different slopes of the scanning waveform in each scanning period are gradually reduced.

In one example, the scanning waveform in the each scanning period only comprises two chamfered sections having with different slopes. Within the each scanning period, of the scanning waveform, a chamfer slope formed by the first potential decrease of the scanning waveform is a first chamfer slope, a chamfer slope formed by the second potential decrease of the scanning waveform is a second chamfer slope, and a magnitude of the first chamfer slope is less than a magnitude of the second chamfer slope.

In one example, the chamfered section having with different slopes of the scanning waveform in the each scanning period is gradually increased.

In one example, the scanning waveform comprises at least three chamfered sections having with different slopes in the each period of the scanning waveform, and a magnitude of the slope of each chamfered section is more than or less than a magnitude of the slope of the adjacent chamfered section.

In one example, the slope of the chamfered section of the scanning waveform is changed by changing a resistance of a discharge resistor in a discharge process of the chamfer circuit.

In one example, the discharge resistor is a digital resistor.

An LCD panel driving circuit comprises a chamfer circuit comprising a resistance control module that adjusts a resistance of a discharge resistor in a discharge process of the discharge resistor.

In one example, the discharge resistor of the chamfer circuit is an adjustable digital resistor, and the resistance control module is a digital control module that controls a change of the resistance of the digital resistor to enable the resistance of the discharge resistor to be changed in the discharge process.

In one example, the chamfer circuit comprises at least two discharge resistors, and each of the discharge resistors is coupled to a discharge function control switch.

In the present disclosure, in a process of driving the LCD panel, the scanning waveform of the VG controlled by the chamfer circuit includes at least two chamfered section having with different slopes in each scanning period of the scanning waveform. Accordingly, when uniformity of a LCD panel is adjusted, adjustable flexibility of the scanning waveform of the voltage is higher, which makes influence of resistance-capacitance delay caused by a resistance and capacitance of different positions of the LCD panel be similar with the slopes of the chamfered sections of the scanning waveform of the voltage, thus, the uniformity of the LCD panel and image display effect both are good.

### BRIEF DESCRIPTION OF FIGURES

FIG. 1 is a control diagram of a chamfered section of a scanning waveform of a liquid crystal display (LCD) panel driving method of the present disclosure;

FIG. 2 is a change diagram of a chamfered section of a scanning waveform of the present disclosure;

FIG. 3 is a control diagram of a chamfer circuit of a first example of the present disclosure;

FIG. 4 is a schematic diagram of a discharge resistor (namely digital resistor) of a first example of the present disclosure;

FIG. 5A-B are a sequence diagram of digital control signals of a first example of the present disclosure;

FIG. 6 is a functional diagram of a first example of the present disclosure;

FIG. 7 is a change diagram of a scanning waveform of a first example of the present disclosure;

FIG. 8 is a schematic diagram of a chamfer circuit of a second example of the present disclosure;

FIG. 9 is a schematic diagram of a uniformity adjustment system of an LCD panel of an example of the present disclosure;

FIG. 10 is a flow diagram of a uniformity adjustment of an LCD panel of an example of the present disclosure;

FIG. 11 is a schematic diagram of several possible types of a scanning voltage waveform of an LCD panel of an example of the present disclosure; and

FIG. 12 is a schematic diagram of a scanning waveform of a driving voltage of an LCD panel in the prior art.

### DETAILED DESCRIPTION

In a liquid crystal display (LCD) panel driving circuit, characteristics of a chamfered section of a scanning waveform of a voltage can be changed by a chamfer circuit. In the present disclosure, by changing slope of the chamfered sections of the scanning waveform of the voltage, the chamfered section of the scanning waveform in each scanning period includes at least two chamfered sections having different slopes. Accordingly, when uniformity of is LCD panel is adjusted, adjustable flexibility of the scanning waveform of the voltage is higher, which makes influence of resistance-capacitance delay caused by a resistance and capacitance of different positions of the LCD panel be similar with the slopes of the chamfered sections of the scanning waveform of the voltage, thus, the uniformity of the LCD panel and image display effect both are good.

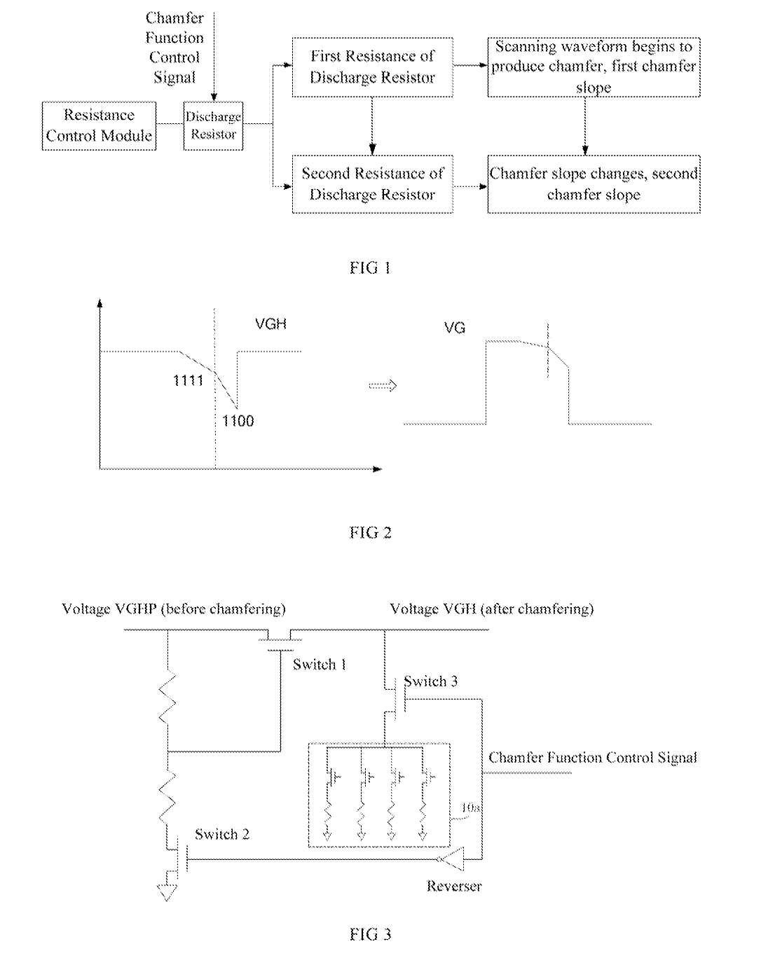

FIG. 1 shows a system used to achieve the aforementioned method where discharge of a discharge resistor of the chamfer circuit is controlled by a chamfer function control signal, and a resistance control module is coupled to the chamfer circuit. Resistance of the discharge resistor in a discharge process of the discharge resistor is controlled by the resistance control module. When the discharge resistor discharges via control of the chamfer function control signal, a voltage waveform of an output voltage signal (VGH) includes a chamfered section. When the discharge resistor is continuously discharging, the resistance of the discharge resistor is adjusted by the resistance control module, and a slope of the chamfered section of the voltage waveform is changed when the resistance of the discharge resistor is changed. As shown in FIG. 2, when the discharge resistor discharges, the voltage waveform of the VGH includes a first potential decrease to form a first chamfered section, where a slope of the first chamfered section is the first chamfer slope, and when the resistance of the discharge resistor is changed, the voltage waveform of the VGH includes a second potential decrease to form a second chamfered section, and a slope of the second chamfered section is the second chamfer slope. A voltage waveform of an output san voltage signal (VG) of the LCD panel generated in accordance with the VGH is formed with two chamfered sections with different slopes as well.

Optionally, it can be determined that if the resistance has changed many times in the process of the discharge resistor continuously discharging to enable the potential to be changed for many times, the chamfer slope can also be changed many times. The voltage waveform of the VG can be changed in accordance with different voltage waveform of the VGH. As shown in FIG. 11, the voltage waveform of the VG can be various types such as a, b, c shown in the FIG.

The present disclosure will further be described in detail in accordance with the figures and the examples.

### Example 1

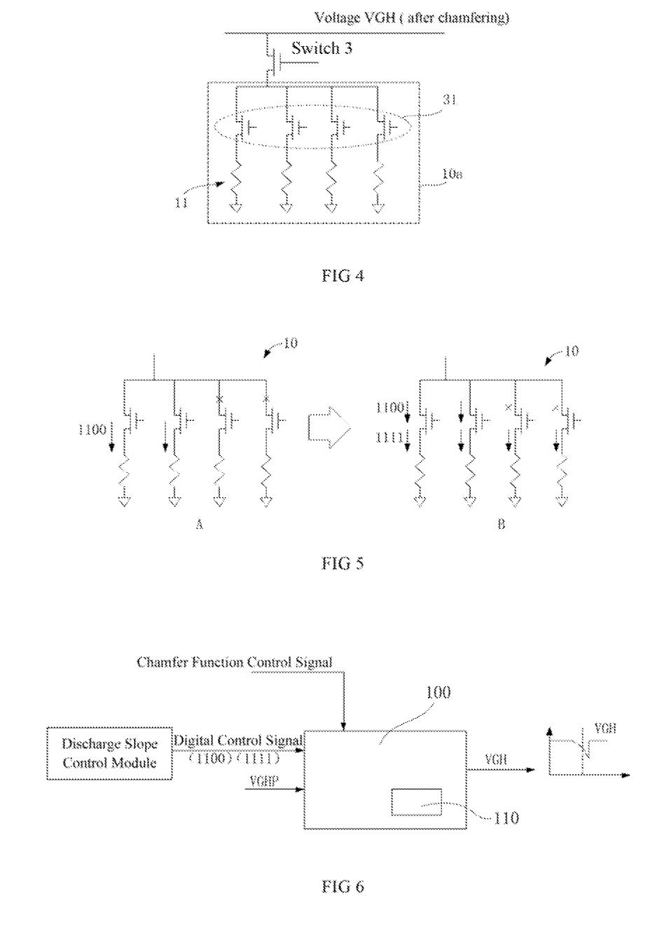

As shown in FIG. 3 and FIG. 4, the discharge resistor 10 of the chamfer circuit is a digital resistor 10a having an adjustable resistance. The chamfer circuit is externally coupled to a resistance control module that directly adjusts the resistance of the digital resistor and then changes the resistance of the discharge resistor (namely digital resistor) in the continuous discharge process of the discharge resistor, and the chamfer slope of the scanning waveform is changed by changing the discharge resistor. The digital resistor comprises sub-resistors 11 that are connected in parallel, and each of the sub-resistor 11 is connected in series with a resistance adjustment switch 31. The discharge slope control module sends a digital control signal to control switch 31 of the corresponding sub-resistor 11 of the digital resistor to obtain the corresponding resistance, the digital resistance 10 is connected in series with a functional main switch 3, and the functional main switch 3 receives signal of the chamfer function control signal and is switch off/on according to the received signal of the chamfer function control signal to achieve a chamfer function, namely where the functional main switch 3 directly controls the discharge of the digital resistor 10.

As shown in FIG. 5 and FIG. 6, to change the chamfered sections and the chamfer slopes of the VGH and the VG the LCD panel driving circuit comprise: a chamfer integrated circuit (IC) 100 that comprises the chamfer circuit, and a digital control module (namely resistance control module) that controls the resistance of the discharge resistor in the discharge process of the discharge resistor of the chamfer IC 100. Discharge of the discharge resistor is controlled by the chamfer function control signal. When the discharge of the discharge resistor of the chamfer circuit enables the scanning waveform to include a chamfered section, the digital control module inputs digital control signals twice in sequence, namely inputs digital control signals twice in a timing sequence, where the digital control signals twice are different. As shown in FIG. 5A and FIG. 5B, if the digital control signal 1100 controls discharge of two sub-resistors, and the digital control signal 1111 controls discharge of four sub-resistors. The digital control signal 1100 and the digital control signals 1111 are input in the timing sequence (as shown in FIG. 5b), namely the digital control signal 1111 are input first, and then the digital control signal 1100 are continuously input, which makes the resistance of the digital resistor 10 change in the discharge process, then a chamfered section of the voltage waveform of the VGH is changed for one time to form two chamfered sections having two slopes, and form two chamfered sections having two slopes as well when corresponding to as scanning waveform of a voltage of the LCD panel.

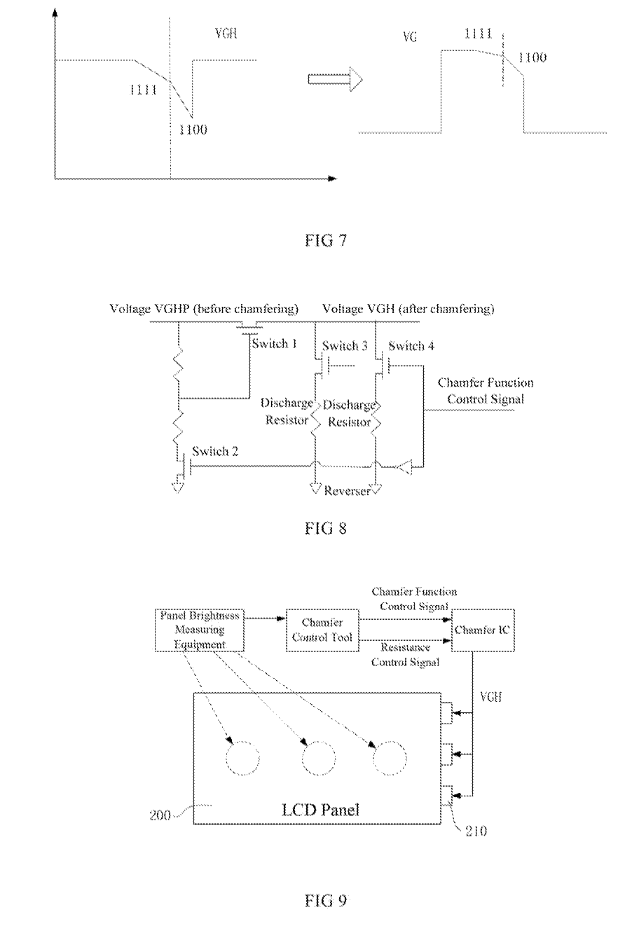

In the example, the digital control signal 1111 is input first, and the resistance of the digital resistor is reduced by four sub-resistors of the discharge resistor at this moment, the four sub-resistors of the discharge resistor are connected in parallel each other. Then, the digital control signal 1100 is input in a continuous discharge process, which increases resistance of the digital resistor 10a, the resistance of the discharge resistor is increased. As shown in FIG. 7, by inputting digital control signals twice in sequence, the slope of the chamfered section of the VGH is changed one time. Thus, the chamfered section of the voltage waveform of the VG of the LCD panel includes two chamfered sections having different slopes correspondingly.

In the example, when the discharge resistor of the chamfer circuit begins to discharge, the first potential decrease occurs. In the discharge process of the discharge resistor (namely digital resistor 10), the second potential decrease occurs when the resistance of the digital resistor 10 is reduced. Thus, the slope of the chamfered section of the voltage waveform of the VGH is reduced. Optionally, if the resistance of the digital resistor 10 is increased, the slope of the chamfered section of the voltage waveform of the VGH is increased. It can be seen that in the discharge process of the discharge resistor, the resistance of the discharge resistor is increased first, then the resistance of the discharge resistor is reduced, as shown in FIG. 11b, thus, the voltage waveform of the VG with three chamfered sections is obtained. Magnitude of a slope of a middle chamfered section is greater than magnitude of a slope of a former chamfered section adjacent to the middle chamfered section and is less than a slope of a latter chamfered section adjacent to the middle chamfered section.

In the example, the chamfer IC can include a memory module 110 that stores a preset value of the digital control signal. The memory module 110 is connected with the digital resistor to record the digital control signal into the memory module 110. Thus, when the driving system of the LCD panel is drived, and the resistance of the digital resistor 10 is directly controlled by the preset value of the digital control signal stored in the memory module without waiting for the digital control signal.

### Example 2

As shown in FIG. 8, the second example is different from the first example in that: the chamfer circuit in the example comprises two discharge resistors, and the two discharge resistors are connected to a switch 3 and a switch 4, respectively. The chamfer slope is changed by controlling the switch 3 and the switch 4. A specific control can be expressed as follows: the switch 3 and the switch 4 are switched on first, and the chamfer slope of the scanning waveform at this moment is the first chamfer slope, then, the switch 4 is switched off, only one discharge resistor discharges at this moment, and the chamfer slope of the scanning waveform is the second chamfer slope.

### Example 3

The present disclosure further provides a uniformity adjustment system of the LCD panel. FIG. 9 shows a specific example of the system. The system comprises a chamfer IC comprising an adjustable resistance, a chamfer control tool that transports the chamfer function control signal and the resistance control signal to the chamfer IC, a panel brightness measuring equipment that measures brightness difference of sub-areas of the LCD panel 200 and feeds back a sub-area brightness difference information to the chamfer control tool. The chamfer control tool sends the resistance control signal to the chamfer IC in accordance with the sub-area brightness difference information, and the chamfer IC charges a drive IC 210 of the LCD panel, and drives the LCD panel to display in accordance with the chamfer function control signal and the resistance control signal. In the system, the adjustable resistor of the chamfer IC is the adjustable resistor 10a (digital resistor) shown in FIG. 3, and all of the sub-resistors are arranged external to the chamfer IC. Thus, influence of heat of the sub-resistors to the chamfer IC is reduced as far as possible. In addition, the chamfer IC further comprises a memory module that stores the resistance control signal (namely digital control signal) input by the chamfer control tool. Thus, when the driving system of the LCD panel is drived, it is not necessary to wait for the digital control signal.

The discharge slope control module of the chamfer circuit controls the chamfer slope so that an average value of the chamfer slope more approximates to an ideal value. Thus, a controllable scope of the uniformity adjustment system of the LCD panel becomes wider, and has more of a flexible application.

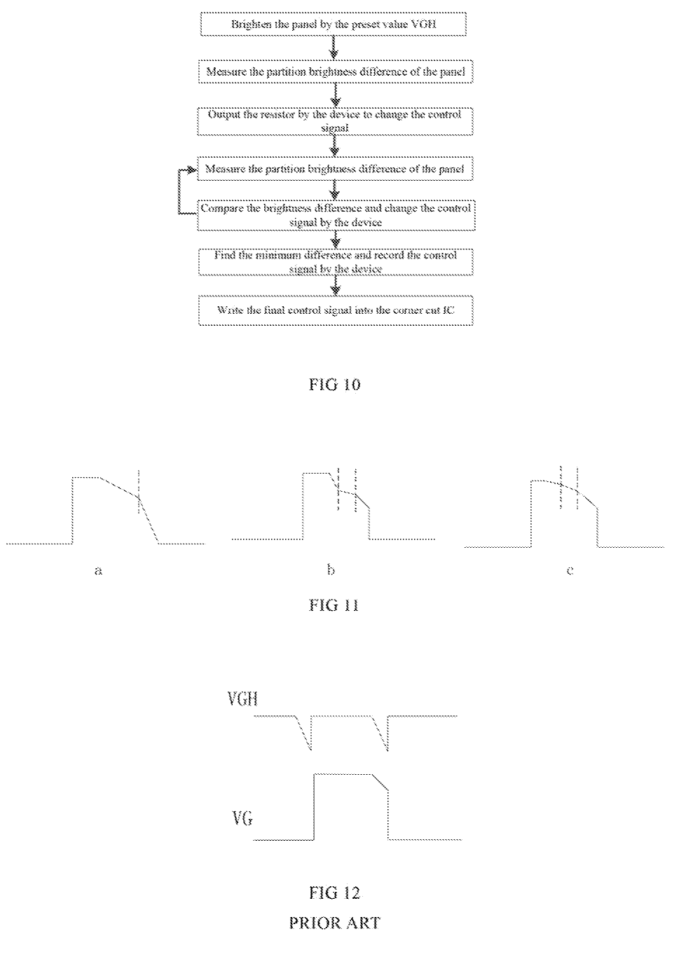

FIG. 10 shows a flow diagram of an operation method of the aforementioned uniformity adjustment system, comprising the following steps:

1. driving a LCD panel with a preset voltage VGH;

2. measuring a sub-area brightness difference of the LCD panel, feeding back the measured result to a chamfer control tool that determines a digital control signal through the sub-area brightness difference;

3. sending the digital control signal to a chamfer IC to change a resistance of to discharge resistor of a chamfer circuit;

4. repeating aforementioned steps until a minimum sub-area brightness difference is found, namely the difference is less than or equal to a preset threshold, determining and recording a digital control signal by the difference, determining an optimal resistance of the discharge resistor, and obtaining an optimal voltage waveform;

5. recording the final digital control signal as preset value into a memory module of the chamfer IC.

The present disclosure is described in detail in accordance with the above contents with the specific preferred examples. However, this present disclosure is not limited to the specific examples. For the ordinary technical personnel of the technical field of the present disclosure; on the premise of keeping the conception of the present disclosure, the technical personnel can also make simple deductions or replacements, and all of which should be considered to belong to the protection scope of the present disclosure.

1. A liquid crystal display (LCD) panel driving method, comprising:
sending a scanning waveform to an LCD panel when the scanning waveform comprises a chamfered section, by control of a chamfer circuit, to drive the LCD panel,
wherein the scanning waveform in each scanning period comprises at least two chamfered sections having different slopes.

2. The liquid crystal display (LCD) panel driving method of claim 1, wherein slope of the chamfered section of the scanning waveform is changed by changing a resistance of a discharge resistor in a discharge process of the chamfer circuit.

3. The liquid crystal display (LCD) panel driving method of claim 2, wherein the discharge resistor is a digital resistor.

4. The liquid crystal display (LCD) panel driving method of claim 1, wherein the slopes of at least two chamfered sections of the scanning waveform are gradually reduced.

5. The liquid crystal display (LCD) panel driving method of claim 4, wherein the scanning waveform only comprises two chamfered sections having different slopes in the each scanning period of the scanning waveform; within the each scanning period of the scanning waveform, a chamfer slope formed by a first potential decrease of the scanning waveform is a first chamfer slope, a chamfer slope formed by a second potential decrease of the scanning waveform is a second chamfer slope, and magnitude of the first chamfer slope is less than magnitude of the second chamfer slope.

6. The liquid crystal display (LCD) panel driving method of claim 5, wherein the first potential decrease is formed by controlling discharge of as discharge resistor of the chamfer circuit, and the second potential decrease is formed by reducing a resistance of the discharge resistor of the chamfer circuit in a discharge process of the chamfer circuit.

7. The liquid crystal display (LCD) panel driving method of claim 1, wherein the slopes of at least two the chamfered sections are gradually increased.

8. The liquid crystal display (LCD) panel driving method of claim 7, wherein the chamfered section having with different slopes in the each scanning period of the scanning waveform is gradually increased by increasing the resistance in a discharge process of a discharge resistor of the chamfer circuit.

9. The liquid crystal display (LCD) panel driving method of claim 1, wherein the scanning waveform comprises at least three chamfered sections having different slopes in the each scanning period of the scanning waveform, and magnitude of the slope of each chamfered section is more than or less than magnitude of the slope of the adjacent chamfered section.

10. A driving circuit that achieves the liquid crystal display (LCD) panel driving method of claim 1, comprising: a chamfer circuit comprising a discharge resistor, and a resistance control module that adjusts a resistance of a discharge resistor in a discharge process of the discharge resistor.

11. The liquid crystal display (LCD) panel driving circuit of claim 10, wherein the discharge resistor of the chamfer circuit is an adjustable digital resistor, and the resistance control module is a digital control module that controls a change of the resistance of the digital resistor to enable the resistance to be changed in the discharge process of the discharge resistor.

12. The liquid crystal display (LCD) panel driving circuit of claim 10, wherein the chamfer circuit comprises at least two discharge resistors, and each of the discharge resistors is coupled to a discharge function control switch.
